(19) United States
(12) Patent Application Publication
(10) Pub. No.: US 2016/0056854 A1
(43) Pub. Date: Feb. 25, 2016

(54) Popup Sleeve for a Mobile Device

(71) Applicant: DCAZE Company Limited, Ma On Shan (HK)

(72) Inventor: Chi Man Leung, Ma On Shan (HK)

(21) Appl. No.: 14/464,101

(22) Filed: Aug. 20, 2014

(51) Int. Cl. H04B 1/3888

(52) U.S. Cl. CPC H04B 1/3888; H04B 2001/3894

(57) ABSTRACT

A sleeve for a mobile computing device. The sleeve includes a top surface, a bottom surface, and an elastic band attached to the bottom surface. The top surface includes a plurality of first edges. The bottom surface includes a plurality of second edges. One or more of the plurality of second edges are attached to one or more of the plurality of first edges for form a pocket for the mobile computing device. The elastic band is configured to be in a stretched state when the mobile computing device is disposed within the pocket and in a not-stretched state when the mobile computing device is not disposed within the pocket. The elastic band is configured to incline a portion of the top surface when in the not-stretched state to provide an inclined surface onto which the mobile computing device may be disposed.

### FIELD OF THE INVENTION

The present invention relates to a popup sleeve for an electronic device.

### BACKGROUND OF THE INVENTION

Mobile computing devices are carried by their users and are thereby subject to physical impacts, spills, or other damage. Numerous cases and sleeves exist for protecting mobile computing devices against such damage.

### SUMMARY OF THE INVENTION

In accordance with one aspect of the present invention, there is provided a sleeve for a mobile computing device. The sleeve includes a top surface, a bottom surface, and an elastic band attached to the bottom surface. The top surface includes a plurality of first edges. The bottom surface includes a plurality of second edges. One or more of the plurality of second edges are attached to one or more of the plurality of first edges for form a pocket for the mobile computing device. The elastic band is configured to be in a stretched state when the mobile computing device is disposed within the pocket and in a not-stretched state when the mobile computing device is not disposed within the pocket. The elastic band is configured to incline a portion of the top surface when in the not-stretched state to provide an inclined surface onto which the mobile computing device may be disposed.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1 illustrates a top plan view of a first embodiment of a mobile device popup sleeve in a not-stretched position, in accordance with an exemplary embodiment of the present invention;

FIG. 2 illustrates a bottom plan view of the mobile device popup sleeve of FIG. 1, in accordance with an exemplary embodiment of the present invention;

FIG. 3 illustrates a right side elevational view of the mobile device popup sleeve of FIG. 1, in accordance with an exemplary embodiment of the present invention;

FIG. 4 illustrates a left side elevational view of the mobile device popup sleeve of FIG. 1, in accordance with an exemplary embodiment of the present invention;

FIG. 5 illustrates a front elevational view of the mobile device popup sleeve of FIG. 1, in accordance with an exemplary embodiment of the present invention;

FIG. 6 illustrates a rear elevational view of the mobile device popup sleeve of FIG. 1, in accordance with an exemplary embodiment of the present invention;

FIG. 7 illustrates a perspective view of the mobile device popup sleeve of FIG. 1, in accordance with an exemplary embodiment of the present invention;

FIG. 8 illustrates a top plan view of the mobile device popup sleeve of FIG. 1 shown in an alternate stretched position, in accordance with an exemplary embodiment of the present invention;

FIG. 9 illustrates a bottom plan view of the mobile device popup sleeve of FIG. 1 shown in the alternate stretched position, in accordance with an exemplary embodiment of the present invention;

FIG. 10 illustrates a bottom plan view of the mobile device popup sleeve of FIG. 1 shown in the alternate stretched position, wherein a flap of the mobile device popup sleeve is unfolded and opened, in accordance with an exemplary embodiment of the present invention;

FIG. 11 illustrates a top plan view of a second embodiment of a mobile device popup sleeve in a not-stretched position, in accordance with an exemplary embodiment of the present invention;

FIG. 12 illustrates a bottom plan view of the mobile device popup sleeve of FIG. 11, in accordance with an exemplary embodiment of the present invention;

FIG. 13 illustrates a right side elevational view of the mobile device popup sleeve of FIG. 11, in accordance with an exemplary embodiment of the present invention;

FIG. 14 illustrates a left side elevational view of the mobile device popup sleeve of FIG. 11, in accordance with an exemplary embodiment of the present invention;

FIG. 15 illustrates a front elevational view of the mobile device popup sleeve of FIG. 11, in accordance with an exemplary embodiment of the present invention;

FIG. 16 illustrates a rear elevational view of the mobile device popup sleeve of FIG. 11, in accordance with an exemplary embodiment of the present invention;

FIG. 17 illustrates a rear perspective view of the mobile device popup sleeve of FIG. 11, in accordance with an exemplary embodiment of the present invention;

FIG. 18 illustrates a front perspective view of the mobile device popup sleeve of FIG. 11, in accordance with an exemplary embodiment of the present invention;

FIG. 19 illustrates a rear perspective view of the mobile device popup sleeve of FIG. 11 shown in an alternate stretched position, wherein an opening of the mobile device popup sleeve is shown opened, in accordance with an exemplary embodiment of the present invention;

FIG. 20 illustrates a top plan view of the mobile device popup sleeve of FIG. 11 shown in the alternate stretched position, in accordance with an exemplary embodiment of the present invention;

FIG. 21 illustrates a bottom plan view of the mobile device popup sleeve of FIG. 11 shown in the alternate stretched position, in accordance with an exemplary embodiment of the present invention;

FIG. 22 illustrates a right side elevational view of the mobile device popup sleeve of FIG. 11 shown in the alternate stretched position, in accordance with an exemplary embodiment of the present invention;

FIG. 23 illustrates a perspective view of an alternative exemplary embodiment of the mobile device popup sleeve of FIG. 1 with a tablet computer disposed thereon, in accordance with an exemplary embodiment of the present invention;

FIG. 24 illustrates a rear perspective view of the mobile device popup sleeve of FIG. 23 with the tablet computer of FIG. 23 disposed thereon, in accordance with an exemplary embodiment of the present invention;

FIG. 25 illustrates a perspective view of the mobile device popup sleeve of FIG. 11 with a tablet computer disposed thereon in a first position, in accordance with an exemplary embodiment of the present invention; and

FIG. 26 illustrates another perspective view of the mobile device popup sleeve of FIG. 11 with the tablet computer of FIG. 25 disposed thereon in a second position, in accordance with an exemplary embodiment of the present invention.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

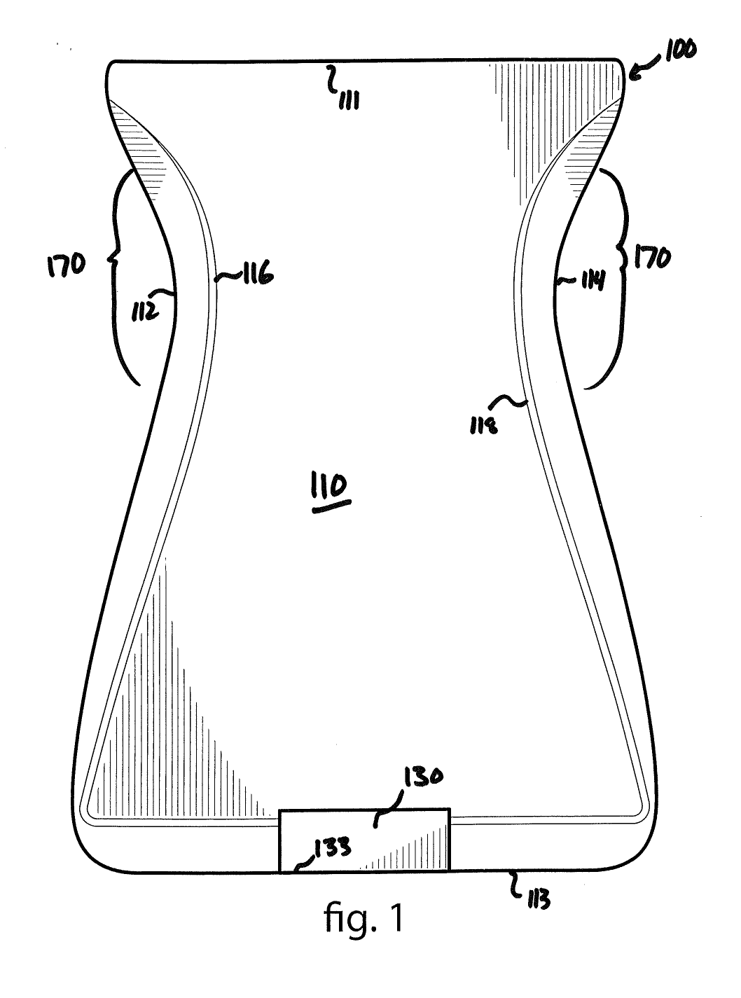

Illustrated in FIGS. 1-10 is a mobile device popup sleeve 100, in accordance with a first embodiment of the present invention. The mobile device popup sleeve 100 serves as both a protective sleeve for a mobile device and a platform onto which the mobile device may be placed when a user is using it. The mobile device may be any mobile computing device, such as a tablet computer, mobile phone, smart phone, etc.

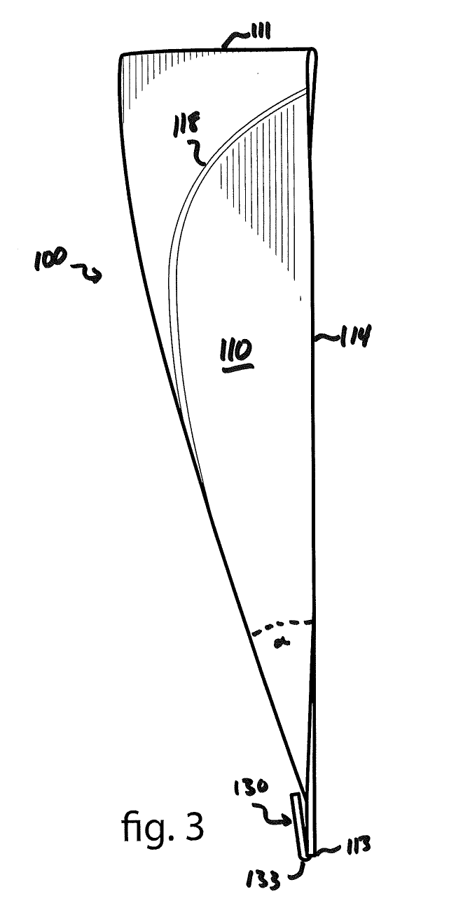

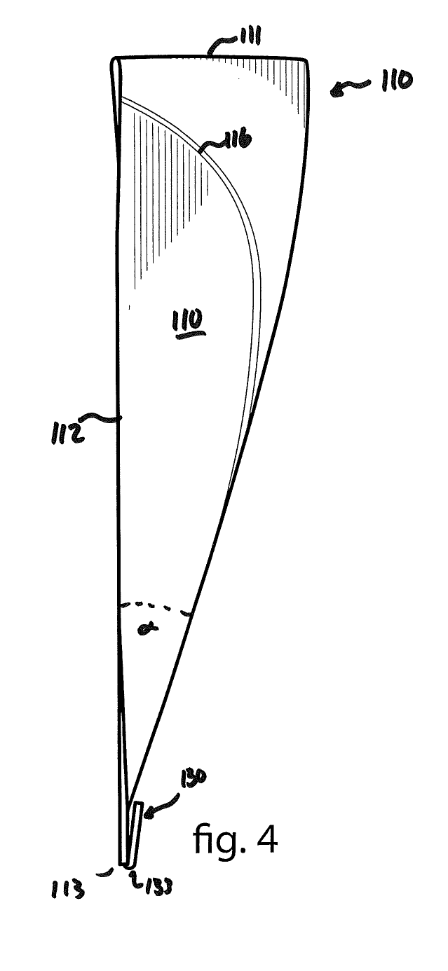

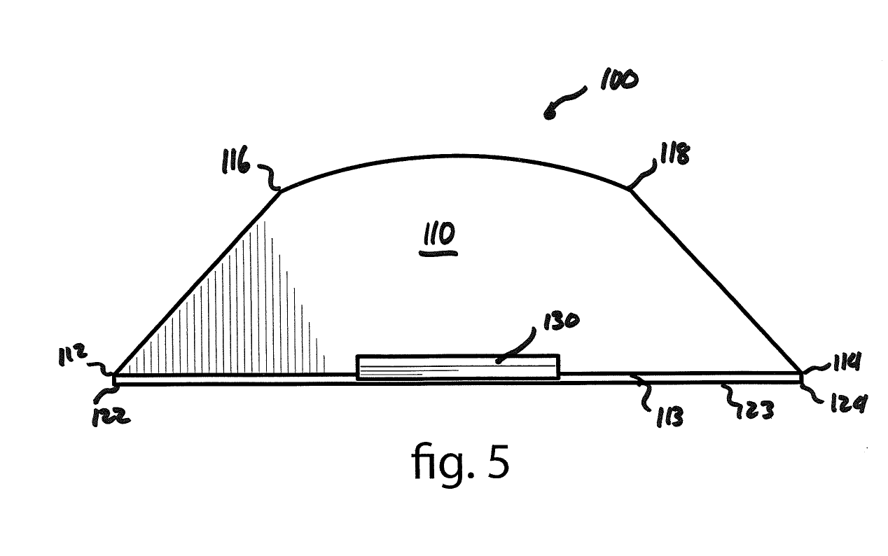

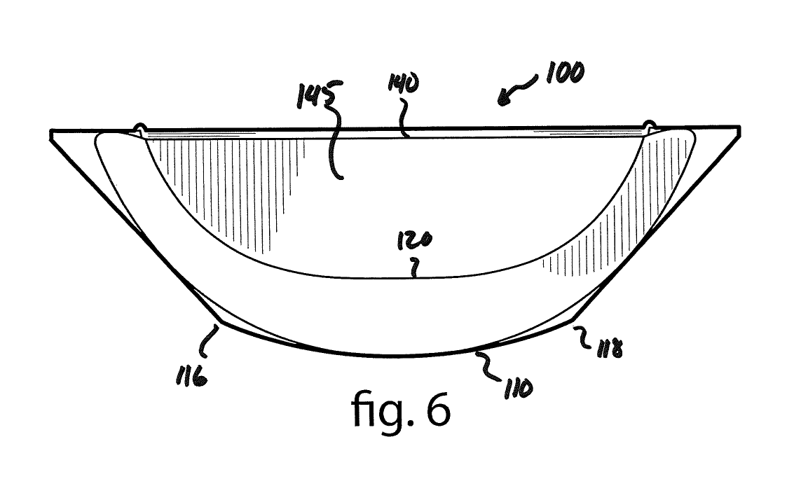

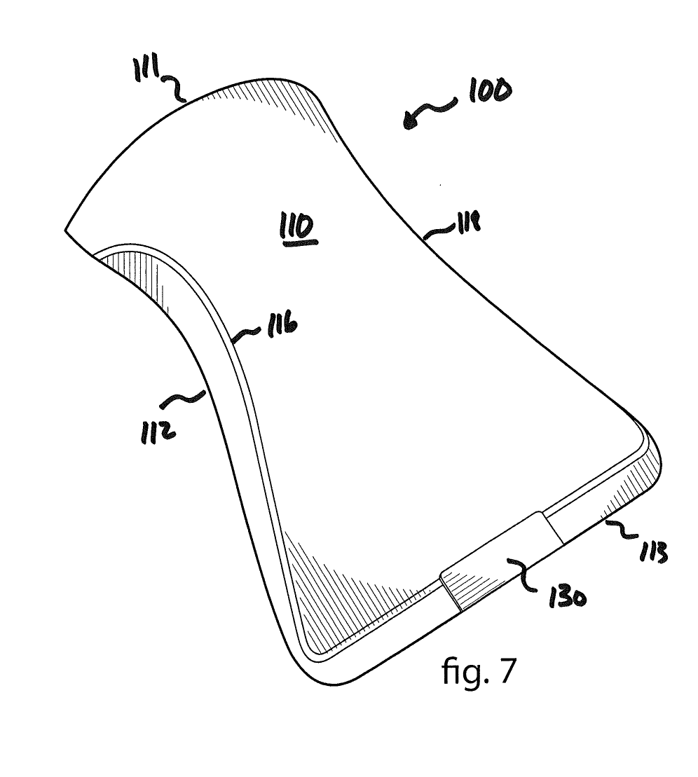

FIG. 1 illustrates a top plan view of the mobile device popup sleeve 100. FIG. 3 illustrates a right side elevational view of the mobile device popup sleeve 100, and FIG. 4 illustrates a left side elevational view of the mobile device popup sleeve 100. FIG. 5 illustrates a front elevational view of the mobile device popup sleeve 100; FIG. 6 illustrates a rear side elevational view of the mobile device popup sleeve 100; and FIG. 7 illustrates a perspective view of the mobile device popup sleeve 100.

Referring to FIGS. 1, 3-5, and 7 together, the mobile device popup sleeve 100 comprises a top surface 110 comprising a rear edge 111, a front edge 113, a left side edge 112, and a right side edge 114. The mobile device popup sleeve 110 further comprises a tab 130 comprising a front edge 133. The front edge 133 of the tab 130 is secured to the front edge 113 of the top surface 110, thereby securing the tab 130 to the top surface 110 of the mobile device popup sleeve 100.

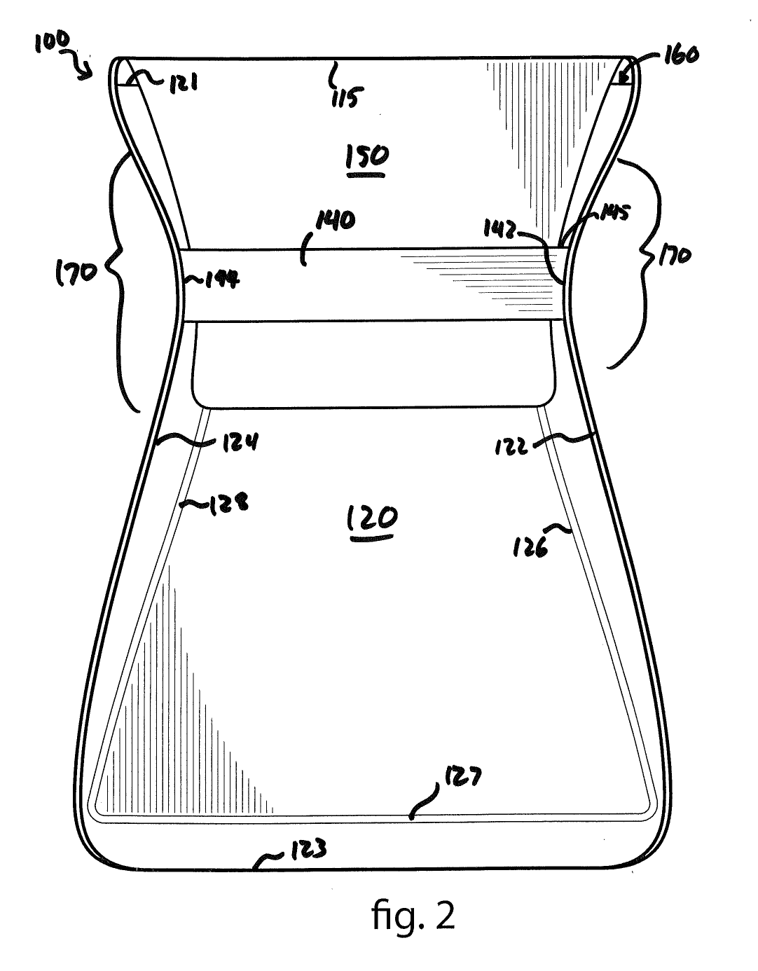

FIG. 2 illustrates a bottom plan view of the mobile device popup sleeve 100. FIG. illustrates is a rear side elevational view of the mobile device popup sleeve 100. Referring together to FIGS. 2 and 6, the mobile device popup sleeve 100 further comprises a bottom surface 120 comprising a rear edge 121, a front edge 123, a left side edge 124, and a right side edge 122. The front edge 123 of the rear surface 120 is attached to the front edge 113 of the top surface 110 of the mobile device popup sleeve 100. The left edge 124 of the bottom surface 120 is attached to the right edge 114 of the top surface 110 of the mobile device popup sleeve 100. The right edge 122 of the rear surface 120 is attached to the left edge 112 of the top surface 110 of the mobile device popup sleeve 100.

As illustrated in FIG. 2, the mobile device popup sleeve 100 further comprises an elastic band 140 and a flap 150. The flap 150 comprises a top edge 151 attached to the rear edge 111 of the front surface 110 of the mobile device popup sleeve 100.

The rear edge 121 of the bottom surface 120 of the mobile device popup sleeve 100 is not attached to the rear edge 111 of the top surface 110 of the mobile device popup sleeve 100. Rather, the rear edge 121 is open and is one side of an opening to a pocket 160 of the mobile device popup sleeve 100. The other side of the opening to the pocket 160 is formed by the top edge 151/top edge 111.

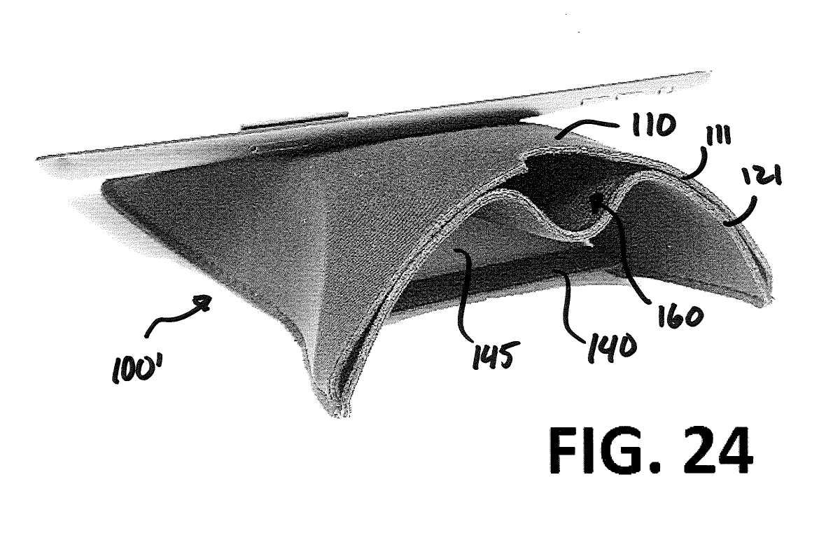

The elastic band 140 comprises a left side edge 144 attached to the left side edge 124 of the bottom surface 120 and a right side edge 142 attached to the right side edge 122 of the bottom surface 120. The elastic band 140 is laterally disposed over the bottom surface 120 from the left side edge 124 to the right side edge 122. The elastic band 140 forms a channel 145 (best seen in FIGS. 6 and 24) between the elastic band 140 and the bottom surface 120. The flap 150 is sized to fit within the channel 145 and be held in a closed position, as shown in FIG. 2, by the channel 145. The elastic band 140 is parallel to the opening of the pocket 160.

FIGS. 1-7 illustrate the mobile device popup sleeve 100 in a not-stretched position when the elastic band 140 is in a not-stretched state. The elastic band 140 is in such state when no mobile device is disposed within the pocket 160. The elastic band 140 when in the not-stretched state pulls the left side edge 112 and the right side edge 114 toward one another, thereby creating a narrow waist 170. The narrow waist 170 causes the top surface 110 and bottom surface 120 to cup in a lateral direction, as best seen in FIGS. 5 and 6. Because the elastic band 140 is disposed laterally across the bottom surface 120 closer to the top edge 121 than to the bottom edge 123, the narrow waist 170 is formed closer to the top edge 121 than to the bottom edge 123, thereby causing the top surface 110 to form an incline having an angle of a, as best illustrated in FIGS. 3 and 4.

In an exemplary embodiment, the mobile device popup sleeve 100 further comprises a number of creases 116-118 and 126-128 that are formed when the mobile device popup sleeve 100 cups (as best seen in FIGS. 5 and 6) and forms an incline in a longitudinal direction (as best seen in FIGS. 3 and 4) when the elastic band 140 is allowed to return to its not-stretched state. The creases 116-118 are formed on the top surface 110, and the creases 126-128 are formed on the bottom surface 120. The creases 116 and 118 are joined near the bottom edge 113 of the top surface 110 by a front crease 117. The creases 126 and 128 are joined near the bottom edge 123 of the rear surface 120 by a front crease 127.

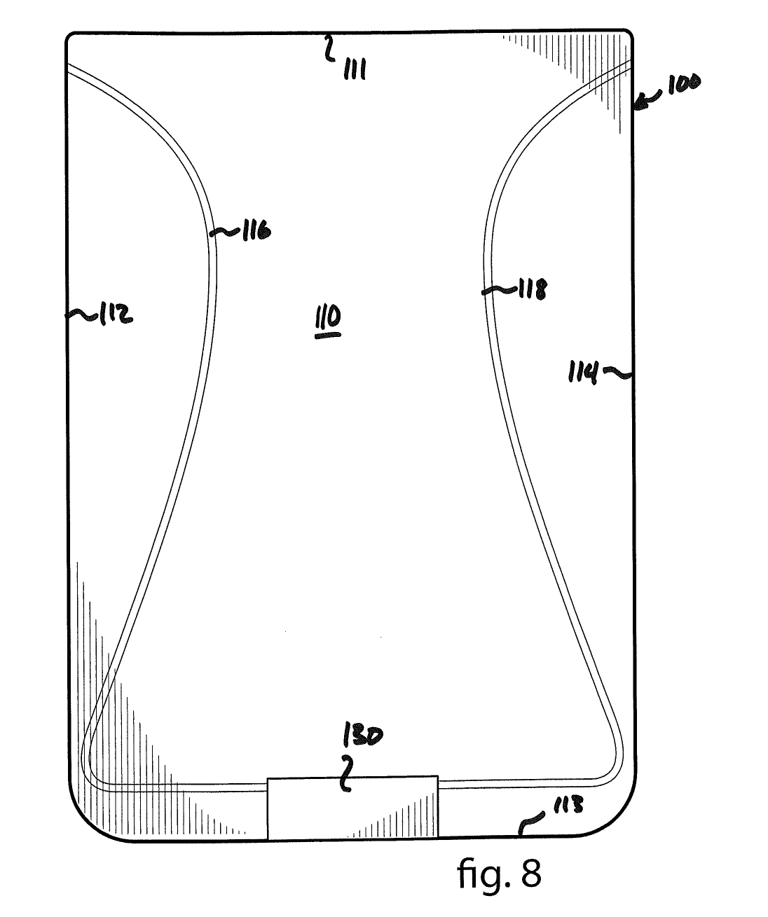

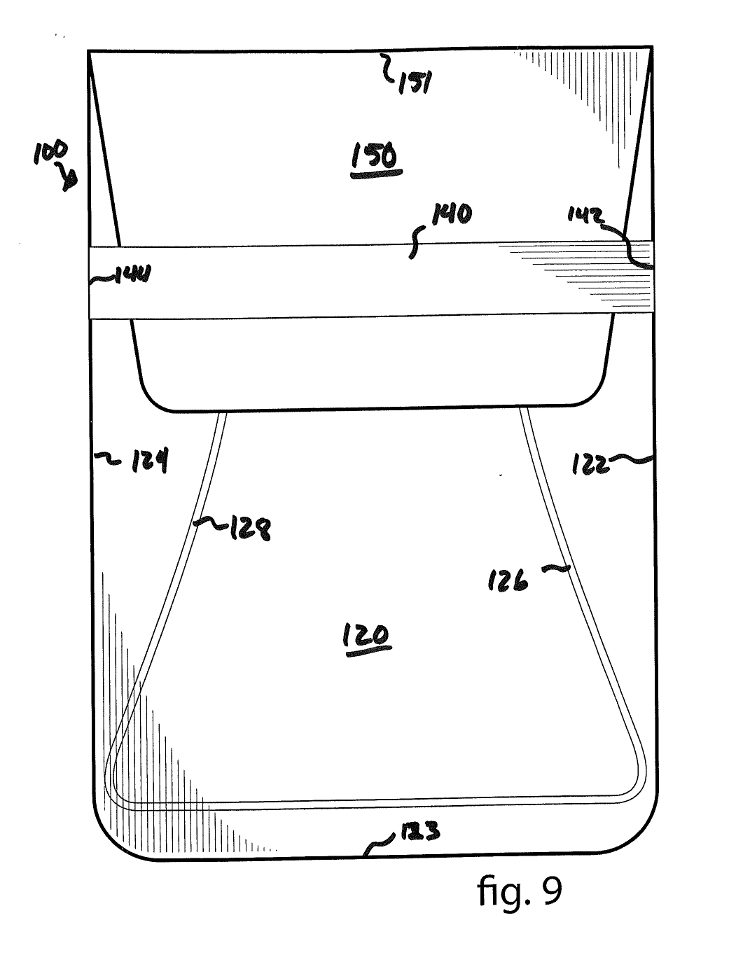

Referring now to FIGS. 8 and 9, there are illustrated, respectively, top and bottom plan views of the mobile device popup sleeve 100 shown in an alternate stretched position when the elastic band 140 is in a stretched state. The mobile device popup sleeve 100 is in the stretched position on account of a mobile device being disposed within the pocket 160. By being disposed within the pocket 160, the mobile device stretches the elastic band 140 to a stretched state so that the narrow waist 170 disappears. The mobile device popup sleeve 100 thereby takes on a generally rectangular, planar shape. The inclined shape seen in FIGS. 3 and 4 and the cup shape seen in FIGS. 5 and 6 are stretched to the flat shape seen in FIGS. 8 and 9.

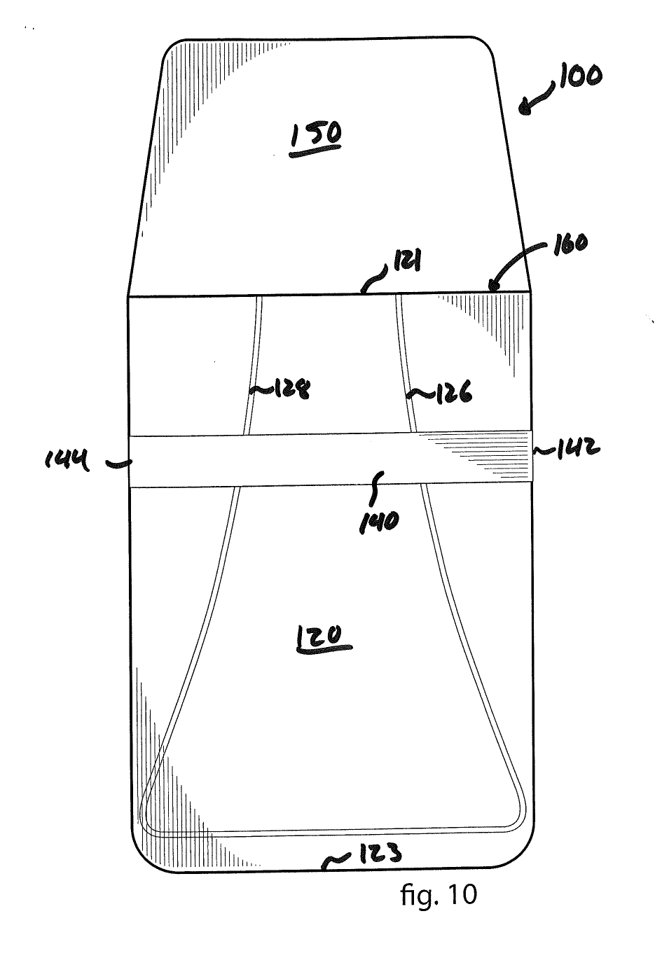

FIG. 10 illustrates the mobile device popup sleeve 100 in the stretched position with the flap 150 opened longitudinally so that the pocket 160 is accessible to remove the mobile device. As used herein with respect to FIGS. 1-10, “lateral” refers to a direction parallel to the opening of the pocket 160, and “longitudinal” refers to a direction perpendicular to the opening of the pocket 160.

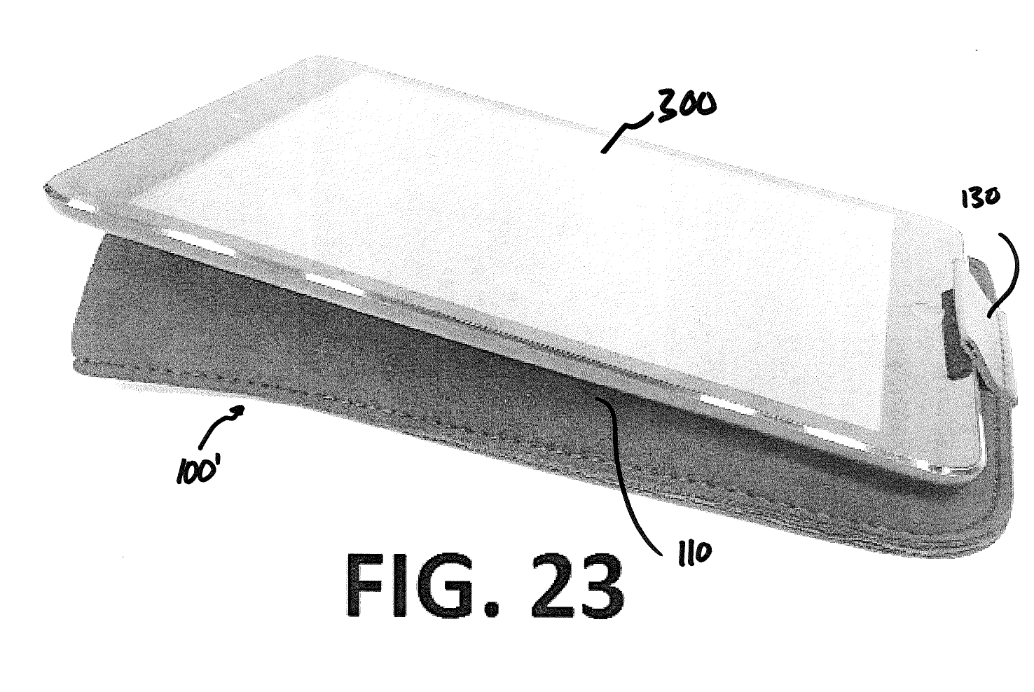

Referring now to FIGS. 23 and 24, there are illustrated front and rear perspective views of an exemplary alternative embodiment of the mobile device popup sleeve 100, generally designated as 100′, in accordance with an exemplary embodiment of the present invention. The mobile device popup sleeve 100′ is generally identical to the mobile device popup sleeve 100, except that the mobile device popup sleeve 100′ lacks a flap 150. Apart from this difference, it is to be understood that all discussion herein regarding the mobile device popup sleeve 100′ is applicable to the mobile device popup sleeve 100 and vice versa.

FIGS. 23 and 24 illustrate that the mobile device popup sleeve 100′ is configured to act as a platform or stand onto which a tablet computer 300 may be placed. The tablet computer 300 is disposed on the top surface 110 of the mobile device popup sleeve 100 and a lower edge of the tablet computer 300 rests under the tab 130. The tab 130 holds the tablet computer 300 on the mobile device popup sleeve 100 when in the not-stretched position.

When in the not-stretched position, the top surface 110 of the mobile device popup sleeve 100, 100′ is inclined in a longitudinal direction (perpendicular to the opening of the pocket 160), as seen in FIGS. 3, 4, and 23. The incline provides for a better viewing angle for a user of the tablet computer 300. Thus, the tab 130 prevents the tablet computer from sliding off the mobile device popup sleeve 100 when inclined.

When in the not-stretched position, the top surface 110 and the bottom surface 120 of the mobile device popup sleeve 100, 100′ is cupped in a lateral direction (parallel to the opening of the pocket 160), as seen in FIGS. 5, 6, and 24. The cup shape provides for a stable base for the mobile device popup sleeve 100, 100′ to hold the tablet computer 300. In this position, the edges 112-114 and 122-124 are in contact with a surface on which the mobile device popup sleeve 100, 100′ rests, thereby providing a stable base for the tablet computer 300.

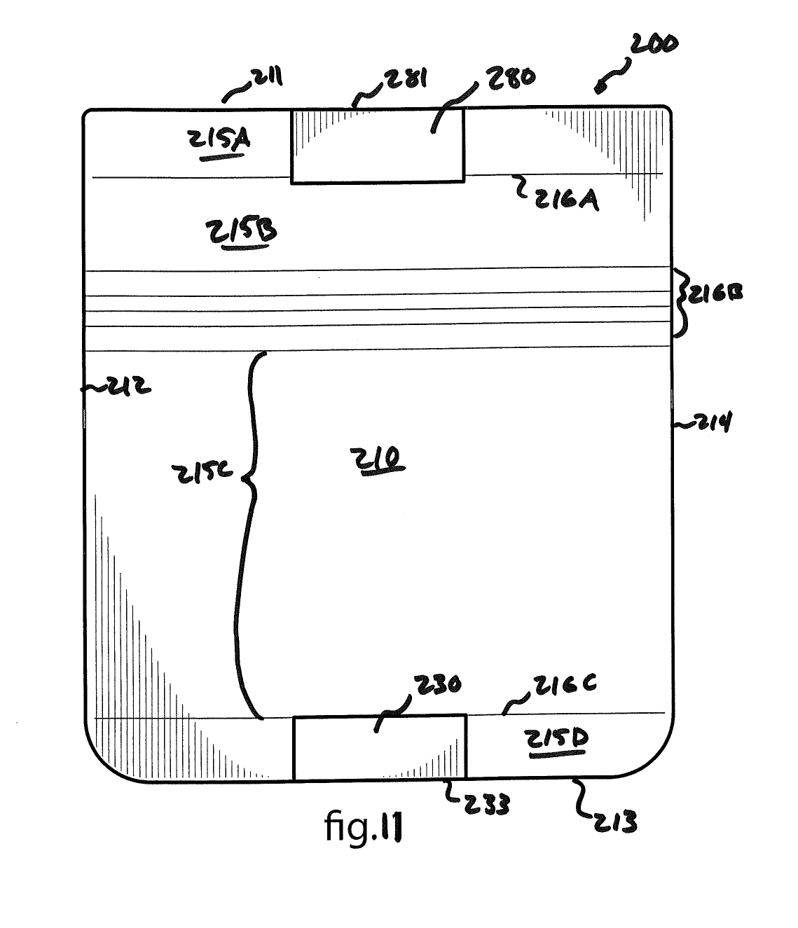

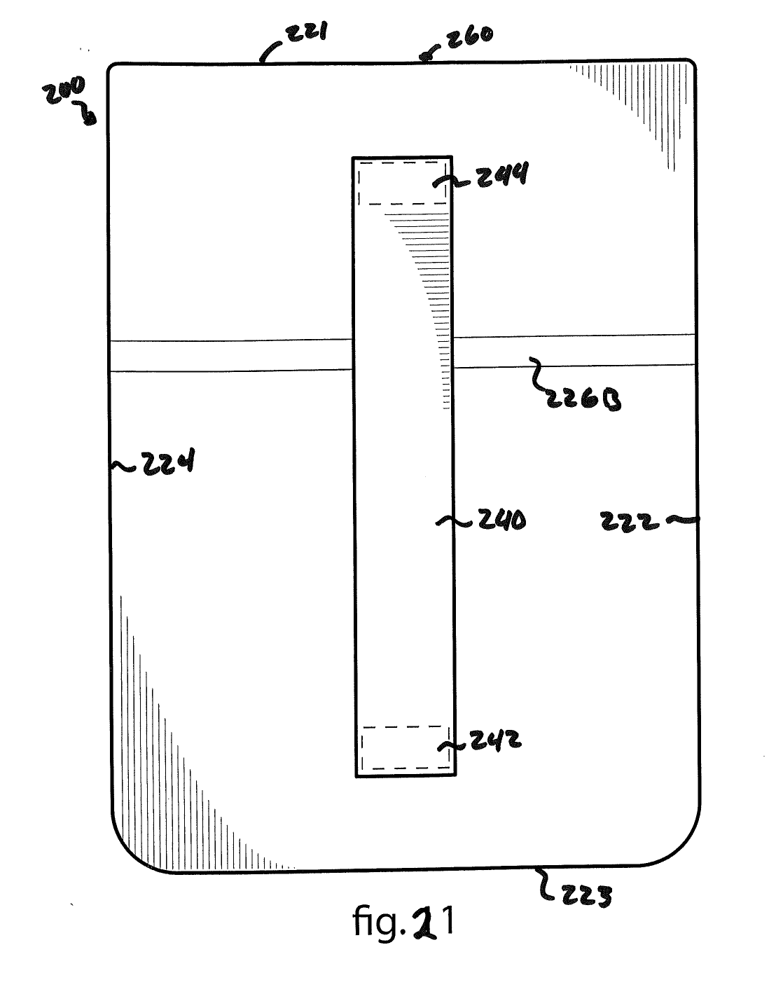

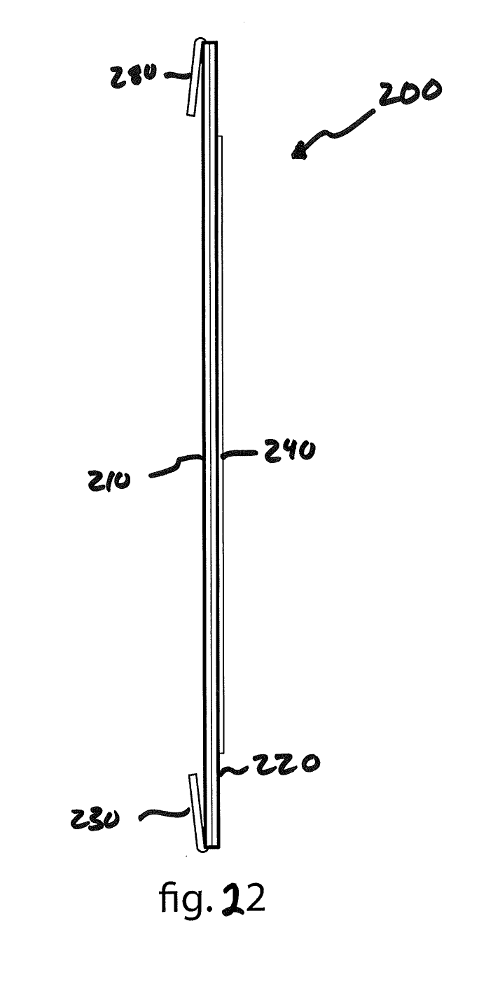

Illustrated in FIGS. 11-22 is a mobile device popup sleeve 200 in accordance with a second embodiment of the present invention. The mobile device popup sleeve 200 serves as both a protective sleeve for a mobile device and a stand onto which the mobile device may be placed when a user is using it. The mobile device may be any mobile computing device, such as a tablet computer, mobile phone, smart phone, etc.

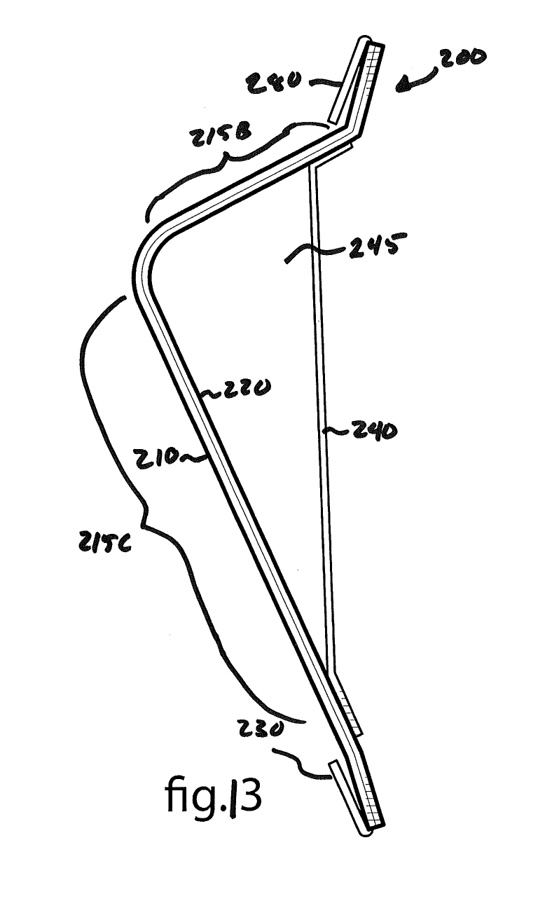

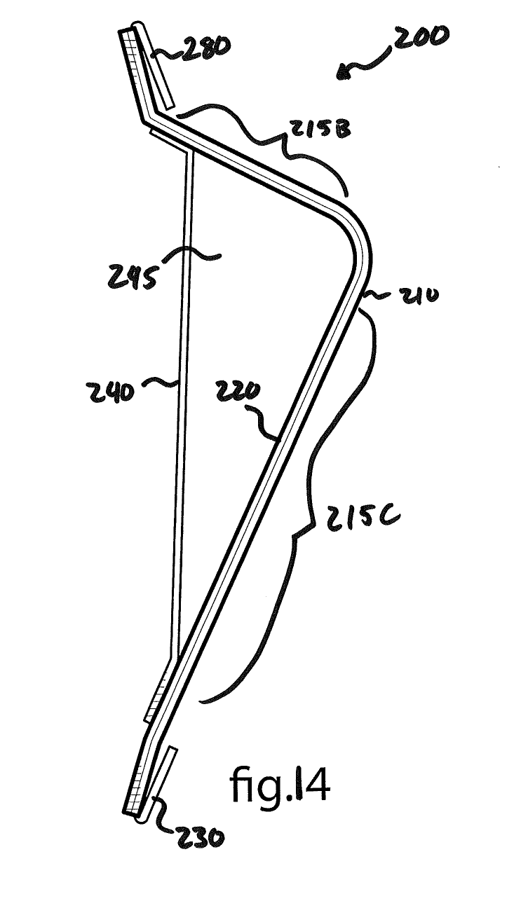

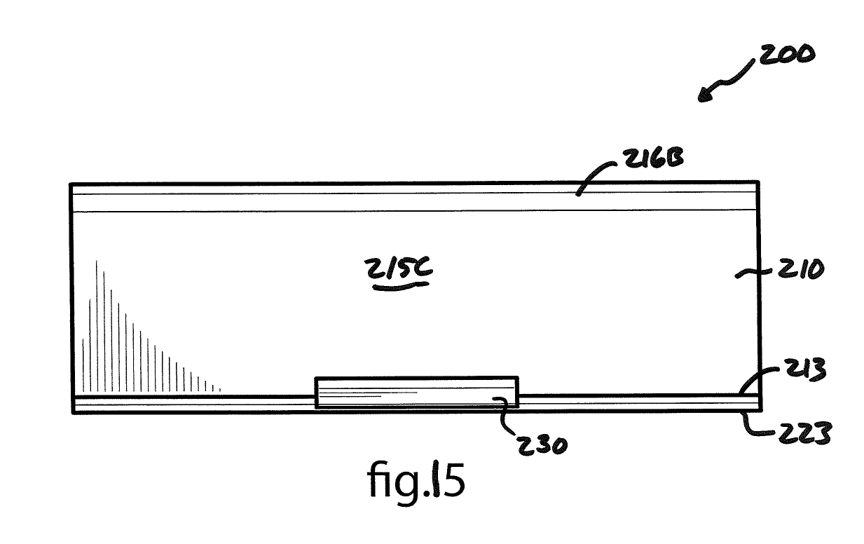

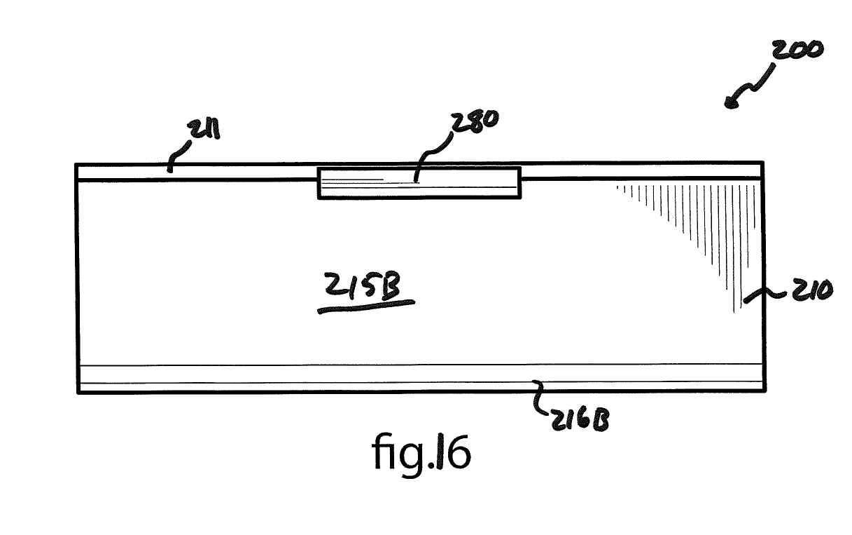

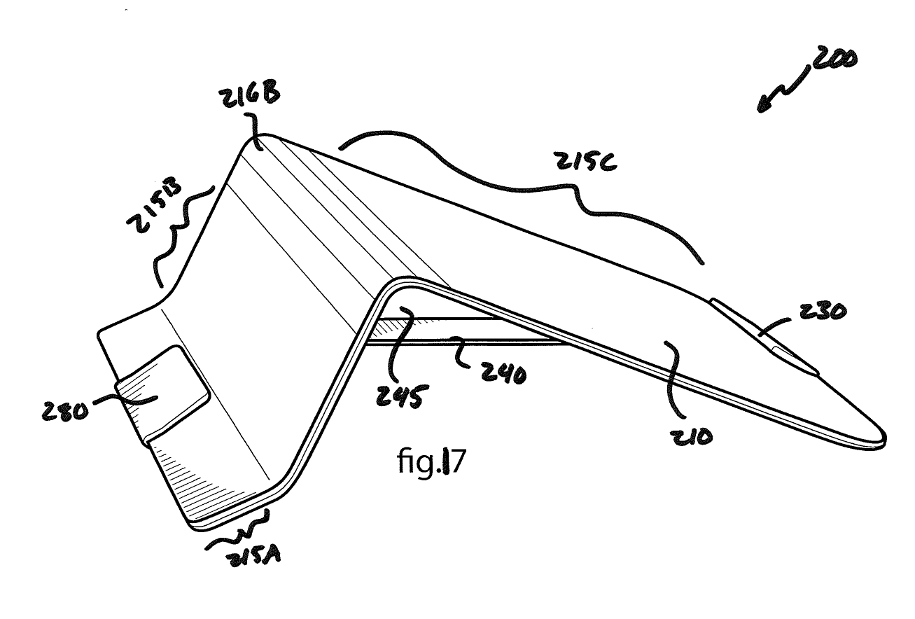

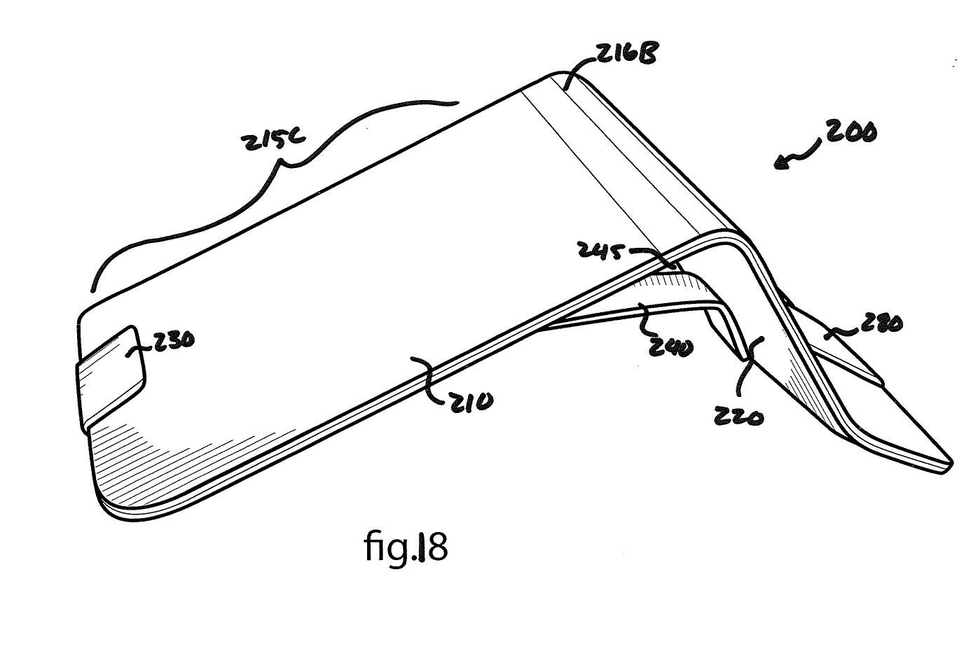

FIG. 11 illustrates a top plan view of the mobile device popup sleeve 200. FIG. 13 illustrates a right side elevational view of the mobile device popup sleeve 200, and FIG. 14 illustrates a left side elevational view of the mobile device popup sleeve 200. FIG. 15 illustrates a front elevational view of the mobile device popup sleeve 200; FIG. 16 illustrates a rear side elevational view of the mobile device popup sleeve 200; FIG. 17 illustrates a rear perspective view of the mobile device popup sleeve 200; and FIG. 18 illustrates a front perspective view of the mobile device popup sleeve 200.

Referring to FIGS. 11 and 13-18 together, the mobile device popup sleeve 200 comprises a top surface 210 comprising a rear edge 211, a front edge 213, a left side edge 212, and a right side edge 214. The mobile device popup sleeve 200 further comprises a front tab 230 comprising a front edge 233 and a rear tab 280 comprising a rear edge 281. The front edge 233 of the tab 230 is secured to the front edge 213 of the top surface 210, thereby securing the tab 230 to the top surface 210 of the mobile device popup sleeve 200.

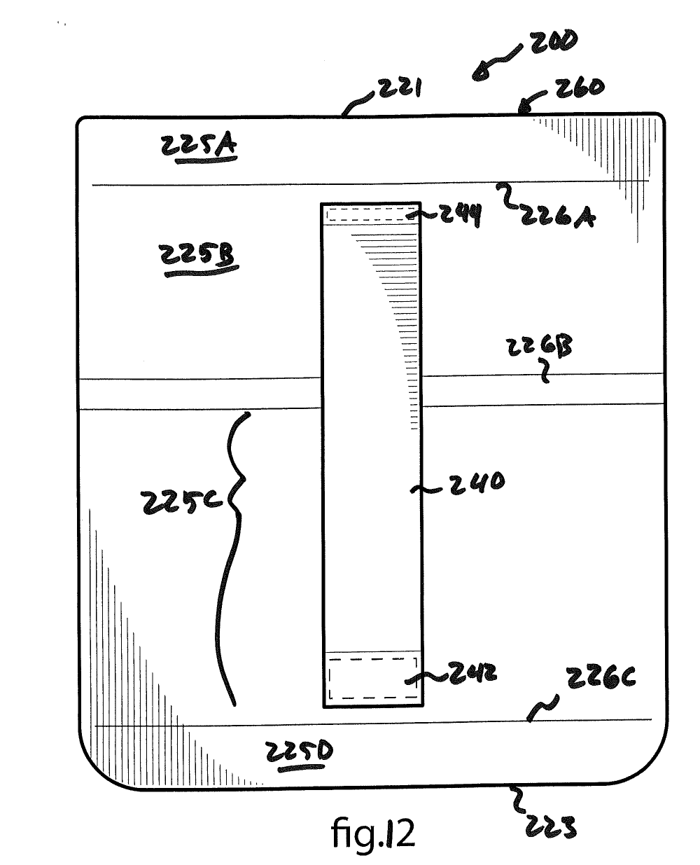

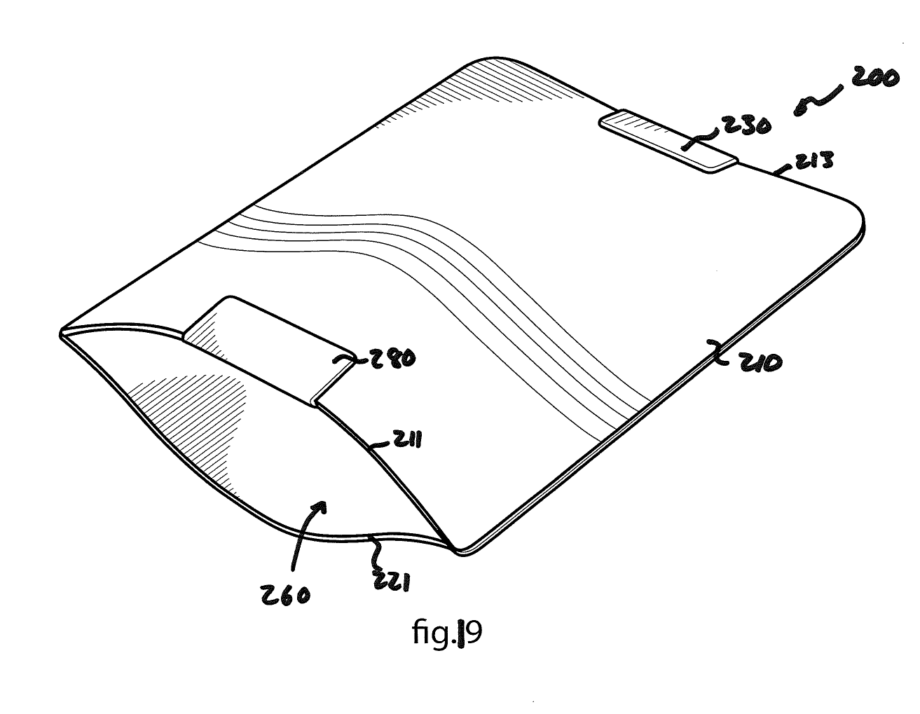

FIG. 12 illustrates a bottom plan view of the mobile device popup sleeve 200. Referring to FIG. 12, the mobile device popup sleeve 200 further comprises a bottom surface 220 comprising a rear edge 221, a front edge 223, a left side edge 224, and a right side edge 222. The front edge 223 of the bottom surface 220 is attached to the front edge 213 of the top surface 210 of the mobile device popup sleeve 200. The left edge 224 of the bottom surface 220 is attached to the right edge 214 of the top surface 210 of the mobile device popup sleeve 200. The right edge 222 of the bottom surface 220 is attached to the left edge 212 of the top surface 210 of the mobile device popup sleeve 200. The rear edge 221 of the bottom surface 220 is not attached to the rear edge 211 of the top surface 210 of the mobile device popup sleeve 200. Rather, the rear edges 211 and 221 form the sides of an opening to a pocket 260 (best seen in FIG. 19) of the mobile device popup sleeve 200.

As illustrated in FIGS. 12-14, the mobile device popup sleeve 200 further comprises an elastic band 240. The elastic band 240 comprises a front portion 242 attached to a front portion of the bottom surface 220 near the front edge 223 and a rear portion 244 attached to a rear portion of the bottom surface 220 hear the rear edge 221. The elastic band 240 is disposed longitudinally over the bottom surface 220 and forms a triangular channel 245 between the elastic band 240 and the rear surface 220. The elastic band 240 is perpendicular to the opening to the pocket 260.

FIGS. 11-18 illustrate the mobile device popup sleeve 200 in a not-stretched position when the elastic band 240 is in a not-stretched state. The elastic band 240 is in such state when no mobile device is disposed within the pocket 260. The elastic band 240 when in the not-stretched state pulls the front edge 213 and the rear edge 211 toward one another, thereby creating the triangularly shaped channel 245 best seen in FIGS. 13 and 14. The shape of the side profile of the mobile device popup sleeve 200 in the not-stretched position is one of a skewed “A,” as best seen in FIGS. 13 and 14.

The mobile device popup sleeve 200 further comprises a number of fold regions 216A, 216B, and 216C on the top surface 210 and a number of fold regions 226A, 226B, and 226C on the bottom surface 220 when the mobile device popup sleeve 200 is in the not-stretched position, i.e., the skewed A shape. The fold regions 216A-C divide the top surface 210 into surface portions 215A, 215B, 215C, and 215D, and the fold regions 226A-C divide the bottom surface 220 into surface portions 225A, 225B, 225C, and 225D. The surface portions 215A and 215B provide a first resting surface for a first position of a mobile device, and the surface portions 215C and 215D provide a second resting surface for a second position of a mobile device. The front portion 242 of the elastic band 240 is attached to the surface portion 225C adjacent to the surface portion 225D, and the rear portion 244 of the elastic band 240 is attached to the surface portion 225B adjacent to the surface portion 225A. When in the not-stretched position (the skewed A), the surface portions 215B and 215C are inclined.

The elastic band 240 when in the not-stretched state pulls the surface portions 215A, 225A and the surface portions 215D, 225D toward one another, thereby creating the skewed A shape for the mobile device popup sleeve 200. Because the fold regions 216B, 226B are formed closer to the rear edge of the mobile device popup sleeve 200 than to the front edge of the mobile device popup sleeve 200, the mobile device popup sleeve 200 forms a skewed A shape rather than a symmetrical A shape.

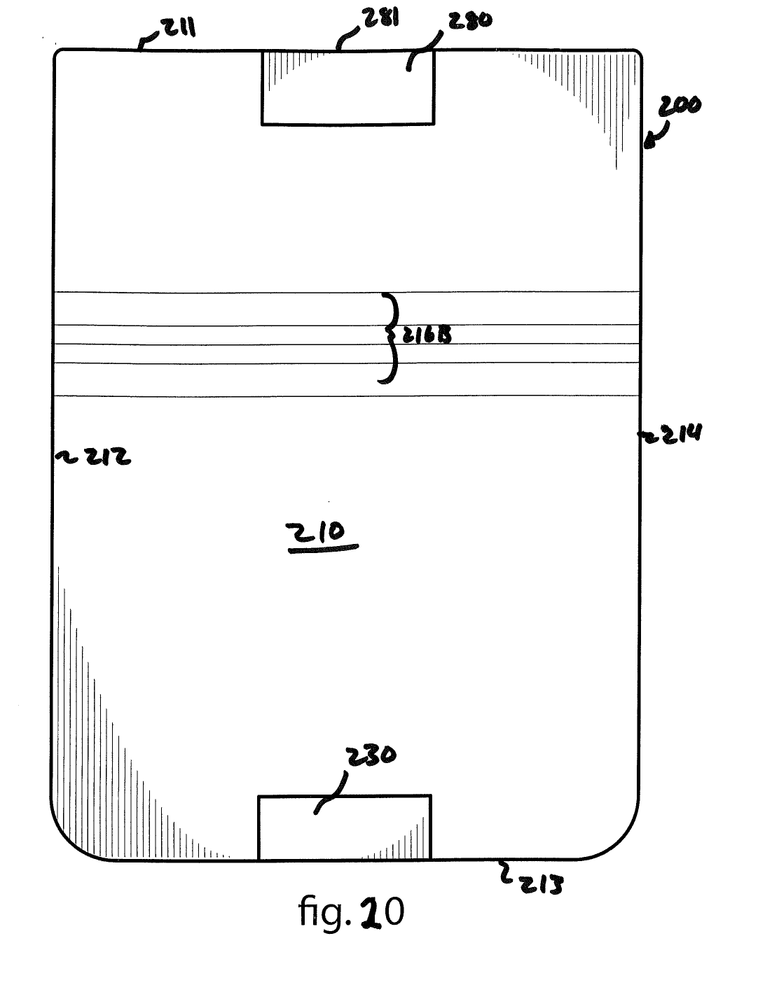

FIGS. 19-22 illustrate the mobile device popup sleeve 200 when in a stretched position. FIG. 19 illustrates a rear perspective view of the mobile device popup sleeve 200 when the elastic band 240 is in the stretched position. FIGS. 20-22 respectively illustrate a top plan view, a bottom plan view, and a right side elevational view of the mobile device popup sleeve 200 when in the stretched position. The mobile device popup sleeve 200 is in the stretched position on account of a mobile device being disposed within the pocket 260, although the mobile device is omitted from FIG. 19 to provide a clear view of the pocket 260. By being disposed within the pocket 260, the mobile device stretches the elastic band 240 to a stretched state so that the skewed A shape of the mobile device popup sleeve 200 changes to a generally rectangular, planar shape.

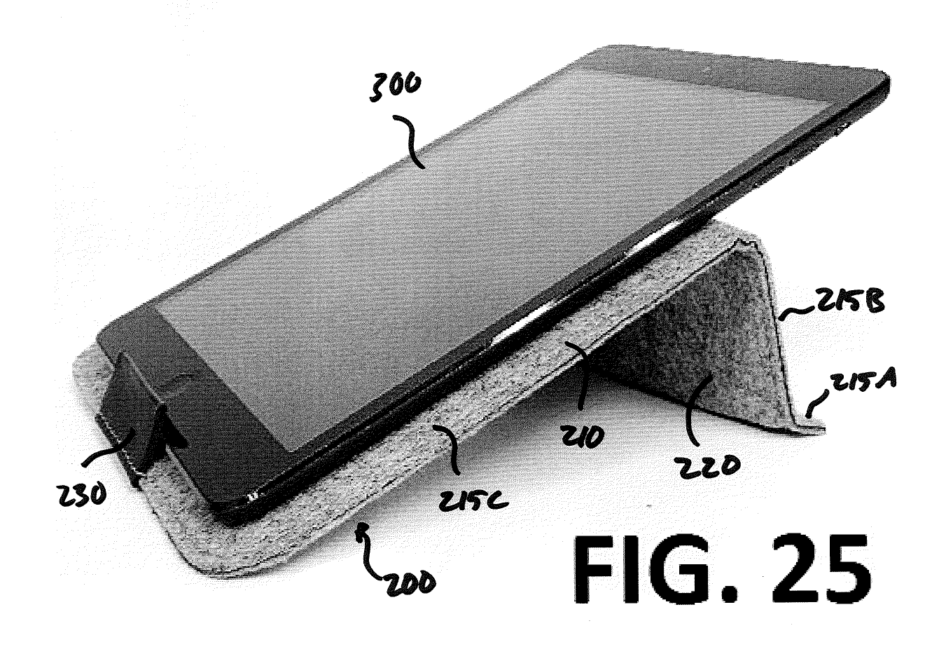

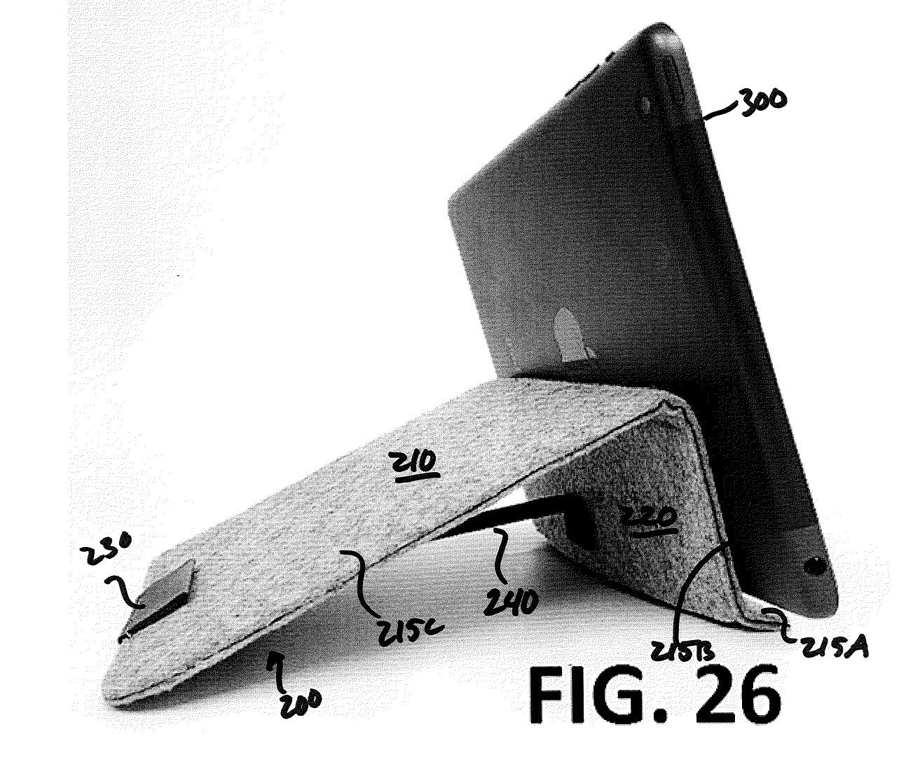

Referring now to FIGS. 25 and 26, there are illustrated two front perspective views of the mobile device popup sleeve 200 onto which the tablet computer 300 has been placed, in accordance with an exemplary embodiment of the present invention. The mobile device popup sleeve 200 thusly acts as a platform or stand for the tablet computer 300.

In FIG. 25, the tablet computer 300 is disposed on the surface portion 215C of the mobile device popup sleeve 200, and a lower edge of the tablet computer 300 rests on the surface portion 215D and under the tab 230. The tab 230 holds tablet computer 300 on the mobile device popup sleeve 200 when in the not-stretched position. When in the not-stretched position, the surface portion 215C of the mobile device popup sleeve 200 is inclined, thereby providing for a better viewing angle for a user of the tablet computer 300, which is inclined upon the surface portion 215C. The tab 230 prevents the tablet computer 300 from sliding off the mobile device popup sleeve 200.

In FIG. 26, the tablet computer 300 is disposed on the surface portion 215B of the mobile device popup sleeve 200, and a lower edge of the tablet computer 300 rests on the surface portion 215A and under the tab 280. The tab 280 holds tablet computer 300 on the mobile device popup sleeve 200 when in the not-stretched position. When in the not-stretched position, the surface portion 215B of the mobile device popup sleeve 200 is inclined, thereby providing for a better viewing angle for a user of the tablet computer 300, which is inclined upon the surface portion 215B. The tab 280 prevents the tablet computer from sliding off the mobile device popup sleeve 200.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A sleeve for a mobile computing device, the sleeve comprising:
a top surface comprising a plurality of first edges;
a bottom surface comprising a plurality of second edges, one or more of the plurality of second edges attached to one or more of the plurality of first edges for form a pocket for the mobile computing device;
an elastic band attached to the bottom surface, the elastic band configured to be in a stretched state when the mobile computing device is disposed within the pocket and in a not-stretched state when the mobile computing device is not disposed within the pocket,
wherein the elastic band is configured to incline a portion of the top surface when in the not-stretched state to provide an inclined surface onto which the mobile computing device may be disposed.

2. The sleeve of claim 1, further comprising a tab attached to one of the plurality of first edges of the top surface.

3. The sleeve of claim 2, wherein the tab comprises an edge connected to the one of the plurality of first edges of the top surface.

4. The sleeve of claim 2, wherein the tab retains the mobile computing device on the inclined surface.

5. The sleeve of claim 1, wherein the elastic band spans the bottom surface laterally.

6. The sleeve of claim 5, wherein the elastic band comprises a left side edge attached to a left side edge of the bottom surface and a right side edge attached to a right side edge of the bottom surface, thereby forming a channel between the elastic band and the bottom surface.

7. The sleeve of claim 1, wherein the elastic band spans the bottom surface longitudinally.

8. The sleeve of claim 7, wherein the elastic band comprises a front portion attached to a front portion of the bottom surface and a rear portion attached to a rear portion of the bottom surface, thereby forming a channel between the elastic band and the bottom surface.

9. The sleeve of claim 1, wherein the sleeve is flat and in a not-stretched position and the elastic band is in a stretched state when the mobile computing device is disposed within the pocket.

10. A sleeve for a mobile computing device, the sleeve comprising:
a top surface comprising a plurality of first edges;
a bottom surface comprising a plurality of second edges, one or more of the plurality of second edges attached to one or more of the plurality of first edges for form a pocket for the mobile computing device, the pocket comprising an opening;
an elastic band attached to the bottom surface and spanning the bottom surface in a direction parallel to the opening of the pocket, the elastic band configured to be in a stretched state when the mobile computing device is disposed within the pocket and in a not-stretched state when the mobile computing device is not disposed within the pocket,
wherein the elastic band is configured to incline a portion of the top surface when in the not-stretched state to provide an inclined surface onto which the mobile computing device may be disposed.

11. The sleeve of claim 10, further comprising a tab attached to one of the plurality of first edges of the top surface.

12. The sleeve of claim 11, wherein the tab comprises an edge connected to the one of the plurality of first edges of the top surface.

13. The sleeve of claim 11, wherein the tab retains the mobile computing device on the inclined surface.

14. The sleeve of claim 10, wherein the elastic band comprises a left side edge attached to a left side edge of the bottom surface and a right side edge attached to a right side edge of the bottom surface, thereby forming a channel between the elastic band and the bottom surface.

15. A sleeve for a mobile computing device, the sleeve comprising:
a top surface comprising a plurality of first edges;
a bottom surface comprising a plurality of second edges, one or more of the plurality of second edges attached to one or more of the plurality of first edges for form a pocket for the mobile computing device, the pocket comprising an opening;
an elastic band attached to the bottom surface and spanning the bottom surface in a direction perpendicular to the opening of the pocket, the elastic band configured to be in a stretched state when the mobile computing device is disposed within the pocket and in a not-stretched state when the mobile computing device is not disposed within the pocket,
wherein the elastic band is configured to incline a portion of the top surface when in the not-stretched state to provide an inclined surface onto which the mobile computing device may be disposed.

16. The sleeve of claim 15, further comprising a tab attached to one of the plurality of first edges of the top surface.

17. The sleeve of claim 16, wherein the tab comprises an edge connected to the one of the plurality of first edges of the top surface.

18. The sleeve of claim 16, wherein the tab retains the mobile computing device on the inclined surface.

19. The sleeve of claim 15, wherein the elastic band comprises a front portion attached to a front portion of the bottom surface and a rear portion attached to a rear portion of the bottom surface, thereby forming a channel between the elastic band and the bottom surface.
